(19) United States
(12) Patent Application Publication
(10) Pub. No.: US 2006/0180525 A1
(43) Pub. Date: Aug. 17, 2006

(54) System and method for beneficiating ultra-fine raw coal with spiral concentrators

(75) Inventors: Larry A. Watters, McMurray, PA (US); Daniel S. Placha, Oakdale, PA (US)

Correspondence Address: Bryan H. Opalko, Esquire;Buchanan Ingersoll PC, One Oxford Centre, 20th Floor, 301 Grant Street, Pittsburgh, PA, 15219, US

(73) Assignee: Sedgman LLC, Pittsburgh, PA (US)

(21) Appl. No.: 11/048,448

(22) Filed: Jan. 31, 2005

(51) Int. Cl. B04C 5/28

(52) U.S. Cl. 209/728; 209/21

(57) ABSTRACT

A system and method is provided for beneficiating, or “cleaning”, ultra-fine raw coal with spiral concentrators. The inventive system includes multiple pre- and post-classification systems to size the finer sized raw mineral to develop a pre-sized mineral fraction within a first size range (approximately 0.15 mm by 0.044 mm). The pre-sized mineral fraction is fed to at least one spiral concentrator, wherein the at least one spiral concentrator separates the pre-sized mineral fraction into clean mineral and refuse by specific gravity. Water may be added to the inlet of the at least one spiral concentrator to maintain a constant flow through the at least one spiral concentrator. Additionally, residual minus 0.044 mm particles may be removed from the clean mineral output by a post classification system.

### FIELD OF THE INVENTION

The present invention is directed generally toward coal preparation plants and, more particularly, toward a system and method for beneficiating, or “cleaning”, ultra-fine raw coal with spiral concentrators.

### BACKGROUND OF THE INVENTION

Coal preparation plants typically separate organic and non-organic solid particles by their specific gravities. Raw mined coal is fed to the coal preparation plant, which separates the raw mined coal into clean coal and refuse. Coal preparation plants generally utilize two basic processing methods for separating coal from rock and varying proportions of striated rock in the coal and pyritic sulfur from the higher quality coal. These two processing methods include heavy media and water based separation methods.

Heavy media separation is the most common beneficiation, or “cleaning”, process for larger sized particles, whereas water based separation processes are more commonly utilized for the finer sized particles. The terms “beneficiating” and “cleaning” are used interchangeably herein and refer to the removal of rock and extraneous contaminants from the raw coal. The finer sized particles are further classified into three sized fractions namely, as fine coal (approximately 1 mm to 0.59 mm by 0.15 mm), ultra-fine coal (approximately 0.15 mm by 0.044 mm) and slimes (approximately 0.044 mm by zero). The size notation “A by B” is common in the coal processing industry, where A denotes the upper size limit of the particle, and B denotes the lower size limit of the particle.

Generally, the water based separation methods used on the finer sized coal depend exclusively on increased gravitational forces, slurry velocity and/or cyclone geometry. Spiral concentrators are more commonly utilized in coal preparation plants for cleaning the fine sized raw coal particles (approx. 1 mm to 0.59 mm by 0.15 mm). Both the spiral concentrators, or circuits, and all of the coarse coal cleaning processes operate on the basic principle that the specific gravity of the clean coal particles is significantly less than the specific gravity of the refuse. Generally speaking, these processes are very accurate and efficient.

In the present state of the art, the size fraction of ultra-fines and slimes (minus 0.15 mm particles) are not beneficiated (cleaned) by separating the raw coal in accordance by differences in specific gravity, and therefore process inefficiencies are present. The ultra-fines and slimes in the present state of the art are either cleaned in froth flotation circuitry, discarded, or reclassified as a finer sized fraction, with the slimes portion (i.e., minus 0.044 mm particles) being discarded. In the latter case, the 0.15 mm by 0.044 mm sized particles (i.e., ultra-fines) are again cleaned in froth flotation circuitry.

Froth flotation circuits depend on the surface characteristics of the coal particles, and the type of flotation reagent to “pre-coat” the coal particle surface. If the particles are “hydrophobic”, the reagent coats the particles which then attach themselves to air bubbles and float to the surface of the froth flotation unit. If the particles are “hydrophilic”, the reagent will not coat the particles and therefore the particles will not attach to the air bubbles and thus sink to the bottom of the froth flotation unit. Typically, the coal and pyritic sulfur particles will be hydrophobic, while the non-carbonaceous rock particles will be hydrophilic. However, these froth flotation circuits require continuous supplies of expensive reagents and/or a combination of high volumes of air and reagents to separate the coal and non-carbonaceous substances in the raw coal feed. Additionally, the process efficiency of the flotation circuits is based almost exclusively on the surface chemistry of the particles. For example, if the coal is oxidized prior to the froth flotation circuits, froth flotation is typically ineffective for separating the clean coal from the refuse. Further, since pyritic sulfur is generally hydrophobic, froth flotation circuits cannot effectively remove the ultra-fine pyritic sulfur from the clean coal.

The present invention is directed toward overcoming one or more of the above-mentioned problems.

### SUMMARY OF THE INVENTION

A system and method is provided for utilizing coal washing spiral concentrators to separate the ultra-fine raw coal slurry into ultra-fine clean coal and refuse slurries.

The inventive system includes a pump feeding the finer raw coal slurry (1 mm to 0.59 mm by zero) from either a sump or the underpan of a deslime screen to a raw coal classifying cyclone. The raw coal cyclone separates the minus 0.15 mm raw coal from the raw feed slurry through the vortex finder (top orifice) of the classifying cyclone. This is the first pre-classifying step in the inventive process. The inventive system may preferably also include a second classifying step to remove a portion of the minus 0.044 mm by zero “slimes” prior to feeding the ultra-fine spiral concentrators.

For the second classifying step, the minus 0.15 mm ultra-fines from the raw coal cyclones are fed to a bank of smaller diameter classifying cyclones. These smaller diameter classifying cyclones can either be pump fed or gravity fed. The smaller diameter classifying cyclones separate the minus 0.044 mm raw coal from the raw feed slurry through the vortex finder (top orifice) of the cyclone. The raw coal feed slurry from the apex (bottom orifice) of these smaller diameter classifying cyclones (either pump fed or gravity fed) represents the pre-classified, ultra-fine feed solids (approximately 0.15 mm by 0.044 mm), which then flows by gravity, or is pumped, to the ultra-fine coal washing spiral concentrators.

The inventive system also includes an ultra-fine coal washing spiral feed distributor, which maintains an equal flow to each of the spiral concentrators via a system of equally sized orifices in the bottom of a collection launder. The ultra-fine raw coal flows through each of the orifices into a series of pipes connected to the coal washing spiral concentrators. The spiral concentrators include a pitched helical trough onto which the ultra-fine raw coal in the form of a slurry is fed. The slurry tangentially enters into the spiral feed inlets. As the coal flows from the inlet into the helix down the trough, a combination of gravitational and drag forces are developed. The clean coal travels with the water in the slurry and migrates to the outer section of the trough. The middlings and non-carbonaceous refuse contaminants, including pyritic sulfur, separate from the clean coal and migrate nearer the inner section of the trough, with the refuse particles at the inner most wall. On the bottom of each of the spirals, two slurry cutters are used to separate the slurries of clean coal, middlings and refuse.

Diluting the feed slurry with the proper amount of water and controlling the flow rate, inlet pressures and tonnage levels at each classifying cyclone, as well as to the spiral concentrators, minimizes particle interaction allowing the individual particles to freely migrate across the spirals and separate in accordance to the specific gravity of the particles. The higher specific gravity particles include non-carbonaceous contaminants, including pyritic sulfur, whereas the low specific gravity particles include a purer species of carbon in the form of clean coal.

The inventive system may preferably also include a tertiary post-classification step to remove any residual minus 0.044 mm by zero “slimes” prior to feeding the clean coal handling section of the coal preparation plant. The processed ultra-fine clean coal slurry (approximately 0.15 mm by 0.044 mm) particles from the ultra-fine spirals are fed to a bank of small diameter clean coal classifying cyclones. The majority of any residual minus 0.044 mm “slimes” is separated from the ultra-fine clean coal slurry through the vortex finder (top orifice) of the these classifying cyclones.

A method according to the present invention is also provided for separation a portion of a finer sized mineral fraction into clean mineral and refuse. The method includes removing, from the finer sized mineral fraction, an ultra-fine mineral fraction having a size approximately 0.15 mm by 0.044 mm, and feeding the ultra-fine mineral fraction to at least one spiral, wherein the at least one spiral separates the ultra-fine mineral fraction into clean mineral and refuse. In one form of the inventive method, the mineral includes coal.

The inventive method may further include the step of removing residual minus 0.044 mm particles from the clean mineral output by the at least one spiral.

It is an object of the present invention to provide a system and method of utilizing coal washing spirals to clean ultra-fine raw coal in accordance with the specific gravity of the particles.

It is further object of the present invention to control the feed and operating parameters of coal washing spirals to improve spiral performance.

It is yet a further object of the present invention to provide a pre-sized, ultra-fine clean coal for the clean coal handling system.

Other objects, aspects and advantages of the present invention can be obtained from a study of the specification, the drawings, and the appended claims.

### BRIEF DESCRIPTION OF THE DRAWING

FIG. 1 is a partial block diagram of a system for beneficiating, or “cleaning”, ultra-fine raw coal with spiral concentrators according to the present invention.

### DETAILED DESCRIPTION OF THE INVENTION

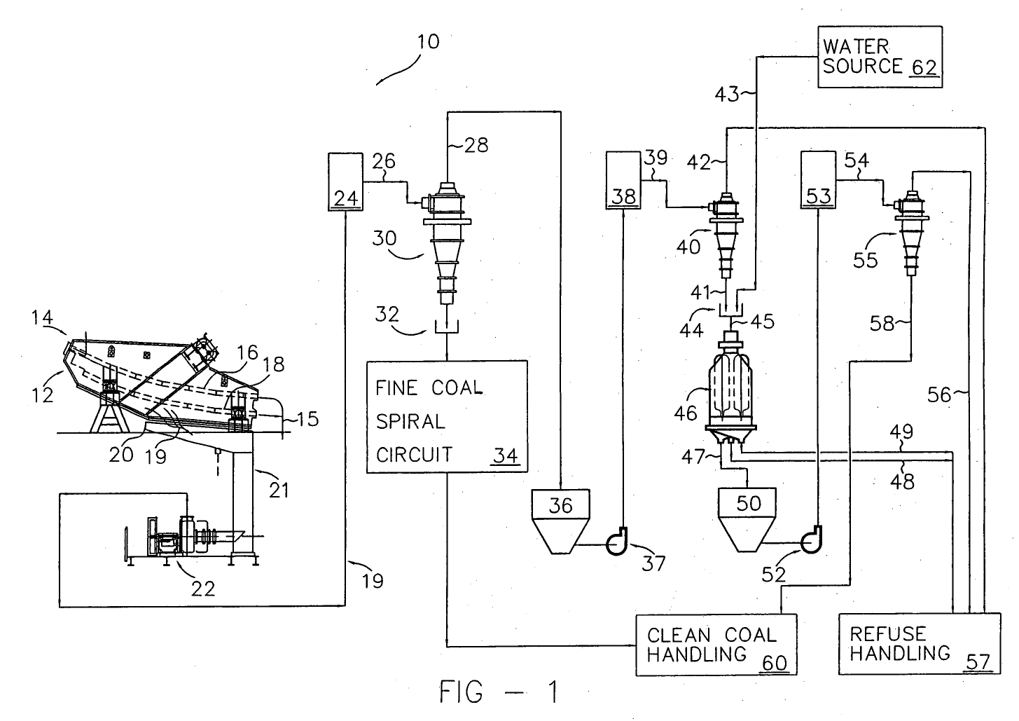

Referring to FIG. 1, a system for beneficiating, or “cleaning”, ultra-fine raw coal with spiral concentrators is illustrated along with other components of a coal preparation plant, shown generally at 10. In order to better understand the inventive system and method, the general operation of the coal preparation plant 10 when processing the finer sized raw coal particles will first be described.

The coal preparation plant 10 includes a deslime screen assembly 12 receiving a raw coal feed 14, which includes a mix of both clean coal and refuse. The deslime screen 12 conventionally separates the raw coal feed into coarse and finer sized coal fractions. The coarse coal fraction 15, which is collected from the top 16 and bottom 18 decks of the deslime screen assembly 12, is fed to a coarse coal processing section (not shown) of the coal preparation plant 10 for conventional processing. The finer sized coal fraction 19 is received in an underpan 20 of the deslime screen assembly 12. While not specifically shown in FIG. 1, the raw coal feed 14 may be pre-wetted with water prior to being received on the deslime screen assembly 12. Accordingly, the underpan 20 of the deslime screen assembly 12 receives a slurry of water and the finer sized raw coal particles 19, with the slurry directed to a column, or sump, 21. The slurry of water and the finer sized raw coal particles 19 is pumped from the underpan 20 and column 21 by a centrifugal pump 22 to a distributor 24.

The distributor 24 equally divides the fine raw coal slurry 19 into fine raw coal slurry portions 26, which are received at the inlets of conventional raw coal classifying cyclones 30 (for convenience, only one cyclone 30 is shown in FIG. 1). The distributor 24 includes a pressure gauge (not shown), which measures the pressure of the fine raw coal slurry 26 input to the classifying cyclone 30. Additionally, the level of slurry in the column 21 is also measured to insure that there is a constant pressure at the inlet of the classifying cyclone 30. If the inlet pressure of the classifying cyclone 30, as measured by the pressure gauge, drops too low, water can be added to the column 21 to bring the pressure back up to the required value. The water can be added either directly to the column 21 or added during the pre-wetting process. Additionally, if necessary, the speed of the pump 22 may also be changed to ensure a constant pressure at the classifying cyclone 30 inlet.

By the pressure generated at the inlet of the cyclone 30 from the feed flow, the minus 0.15 mm raw coal (i.e., ultra-fines and slimes) is separated from the raw feed slurry 26 through the vortex finder (top orifice) of the classifying cyclone 30. This technology is well known in the industry by those skilled in the art and is the first pre-classifying step in the inventive process. The raw coal classifying cyclones 30 conventionally process the fine raw coal slurry portions 26, separating them into ultra-fine raw coal and slimes 28 (minus 0.15 mm by zero reporting to the cyclone vortex finder) and fine raw coal slurries 32, which are fed to a conventional fine coal spiral circuit 34 of the coal preparation plant 10.

The ultra-fine raw coal 28 output by the raw coal cyclones 30 is received by a sump 36 and pumped, via pump 37, to a distributor 38 which equally splits the ultra-fine raw coal flow 28 into ultra-fine raw coal slurry portions 39, which are received at a bank of conventional ultra-fine raw coal cyclones 40 (for convenience, only one cyclone 40 is shown in FIG. 1). The distributor 38 includes a pressure gauge (not shown), which measures the pressure of the ultra-fine raw coal slurry 39 input to the ultra-fine raw coal cyclone 40. Additionally, the level of slurry in the sump 36 is also measured to ensure that there is a constant pressure at the inlet of the ultra-fine raw coal cyclone 40. If the inlet pressure, as measured by the pressure gauge, drops too low, water can be added to the sump 36 to bring the pressure back up to the required value. Additionally, if necessary, the speed of the pump 37 may also be changed to ensure a constant pressure at the ultra-fine raw coal cyclone 40 inlet.

The cyclones 40 separate the ultra-fine raw coal slurries 39 into slimes 42 (minus 0.044 mm) and pre-sized ultra-fine raw coal 41 (approximately 0.15 mm by 0.044 mm). By the pressure generated at the inlet of the cyclones 40 from the feed flow, the minus 0.044 mm slimes 42 are separated from the raw feed slurry 39 through the vortex finder (top orifice) of the cyclone 40, as is known in the art. The slimes 42 from the ultra-fine raw coal cyclones 40 report to a conventional refuse handling section 57 of the coal preparation plant 10. The pre-sized ultra-fine raw coal 41 from the ultra-fine raw coal cyclones 40 is mixed with water 43 from a water source 62, and fed to a bank of ultra-fine coal washing spirals 46, via an ultra-fine coal spiral distributor 44 (for convenience, only one spiral 46 is shown in FIG. 1).

Alternately, the ultra-fine raw coal slurry 28 may be gravity fed to the distributor 38. If gravity fed, the inventive system will include a collection launder (not shown) at the site of the raw coal classifying cyclones 30, which collects the ultra-fine raw coal 28 separated from within the fine raw coal classifying cyclone 30. The difference in elevation between the raw coal classifying cyclones 30 and the ultra-fine raw coal classifying cyclones 40 (minus friction loss) represents the inlet pressure of the ultra-fine raw coal classifying cyclones 40. The minimum feed pressure at the smaller diameter classifying cyclones 40 should be approximately 20 lbs. per square inch. By the pressure generated at the inlet from the feed flow to the smaller diameter classifying cyclones 40, the minus 0.044 mm slimes 42 are separated from the raw feed slurry 28 through the vortex finder (top orifice) of the cyclone 40.

The feed slurry 41 from the apex (bottom orifice) of these smaller diameter classifying cyclones 40 (either pump fed or gravity fed) represents the pre-classified ultra-fine feed solids (approximately 0.15 mm by 0.044 mm), which then flows by gravity to the ultra-fine coal washing spiral concentrators 46. The inventive system also includes an ultra-fine coal washing spiral feed distributor 44, which divides the ultra-fine raw coal 41 and water 43 mixture into raw coal slurry portions 45 and maintains an equal flow to each of the spiral concentrators 46, via a system of equally sized orifices in the bottom of a collection launder (not shown). The ultra-fine raw coal slurry portions 45 flow through each of the orifices into a series of pipes connected to the coal washing spiral concentrators 46.

The spirals 46 separate the raw coal slurry portions 45 (approximately 0.15 mm by 0.044 mm) into different fractions of clean coal 47, middlings 48 and refuse 49. The spiral concentrators 46 include a pitched helical trough into which the ultra-fine raw coal in the form of a slurry is fed. The slurry tangentially enters into the spiral feed inlets. As the coal flows from the inlet into the helix down the trough, a combination of gravitational and drag forces are developed. The clean coal 47 travels with the water in the slurry and migrates to the outer section of the trough. The middlings 48 and non-carbonaceous refuse 49 contaminants separate from the clean coal 47 and migrate nearer the inner section of the trough, with the refuse particles 49 at the inner most wall. Pyritic sulfur particles, which heretofore have been difficult to remove with froth flotation circuits, will be included in the refuse particles 49. On the bottom of the spiral 46, two slurry cutters are used to separate the slurries of clean coal 47, middlings 48 and refuse 49. The ultra-fine refuse fraction 49 is fed to the conventional refuse handling section 57. While the middlings 48 are illustrated in FIG. 1 as also being fed to the refuse handling section 57, depending on the desired clean coal quality, the middlings 48 can be added to either the clean coal 47 or the refuse 49 streams, or again recirculated to sump 36 for reprocessing.

Diluting the feed slurry with the proper amount of water and controlling the flow rate and tonnage levels prior to the spiral concentrators 46, as well as maintaining a constant pressure at the spiral 46 inlet, minimizes particle interaction, allowing the individual particles to freely migrate across the spiral and separate in accordance to the specific gravity of the particles. The higher specific gravity particles include non-carbonaceous contaminants as well as pyretic sulfur, whereas the low specific gravity particles include a purer species of carbon in the form of clean coal. It is contemplated herein that optimum spiral 46 performance will occur if the spirals 46 are operated at a tonnage rate of approximately 0.5 to 1.5 tons per hour per start. Additionally, the inventive system may preferably also include a tertiary post-classification step to remove any residual minus 0.044 mm by zero “slimes” prior to feeding to the clean coal handling section 60, as will be described below.

The ultra-fine clean coal 47 (approximately 0.15 mm by 0.044 mm particles) is collected in a sump 50 and transferred, via a pump 51, to a distributor 53 which divides the ultra-fine clean coal 47 and feeds the equally split slurry portions 54 to a bank of ultra-fine clean coal desliming cyclones 55 (for convenience, only one cyclone 55 is shown in FIG. 1). The distributor 53 includes a pressure gauge (not show), which measures the pressure of the ultra-fine clean coal slurry 47 input to the ultra-fine clean coal desliming cyclones 55. Additionally, the level of slurry in the sump 50 is also measured to ensure that there is a constant pressure at the inlet of the ultra-fine clean coal desliming cyclone 55. If the inlet pressure, as measured by the pressure gauge, drops too low, water can be added to the sump 50 to bring the pressure back up to the required value. Additionally, if necessary, the speed of the pump 52 may also be changed to ensure a constant pressure at the ultra-fine clean coal desliming cyclone 55 inlet. Alternately, the ultra-fine clean coal slurry 47 may be gravity fed to the distributor 53, as is known in the art.

The ultra-fine clean coal desliming cyclones 55 separate the slurry portions 54 into residual slimes 56 and ultra-fine clean coal 58. By the pressure generated at the inlet of the cyclone 55 from the feed flow, the majority of any residual minus 0.044 mm “slimes” 56 is separated from the ultra-fine clean coal slurry through the vortex finder (top orifice) of the classifying cyclone 55. The residual slimes 56 from the ultra-fine clean coal desliming cyclones 55 report to the conventional refuse handling section 57. The pre-sized ultra-fine clean coal 58 reports to the conventional clean coal handling system 60.

It should be understood that while the ultra-fine raw coal cyclones 40 are shown as directly feeding the ultra-fine coal washing spiral distributor 44, a separate sump and pump may be incorporated in the ultra-fine coal washing system without departing from the spirit and scope of the present invention.

By monitoring and controlling the feed and other operating parameters of the ultra-fine coal washing spirals, the inventive system improves the overall performance of the ultra-fine coal washing spirals.

While the present invention has been described with particular reference to the drawings, it should be understood that various modifications could be made without departing from the spirit and scope of the present invention. For instance, while single units are illustrated in FIG. 1, multiple units may be utilized without departing from the spirit and scope of the present invention. Still further, while the inventive system has been shown and described herein as used in a coal preparation plant 10, the inventive system may be utilized in preparation plants for ore and minerals other than coal without departing from the spirit and scope of the present invention.

We claim:

1. In a mineral preparation plant receiving a raw mineral feed and separating the raw mineral feed into coarse and finer sized mineral fractions, a system for separating a portion of the finer sized mineral fraction into clean mineral and refuse, said system comprising:
at least one first classifying cyclone receiving the finer sized mineral fraction and separating the finer sized mineral fraction into a first mineral fraction greater than a predetermined first size and a second mineral fraction smaller than the predetermined first size;
at least one second classifying cyclone receiving the second mineral fraction and separating the second mineral fraction into a third mineral fraction greater than a predetermined second size and a fourth mineral fraction smaller than the predetermined second size; and
at least on spiral receiving the third mineral fraction and separating the third mineral fraction into clean mineral and refuse.

2. The system of claim 1, wherein water is added to the third mineral fraction at the at least one spiral inlet to maintain a constant flow through the at least one spiral.

3. The system of claim 1, wherein the predetermined first size is approximately 0.15 mm, the predetermined second size is approximately 0.044 mm, and wherein the third mineral fraction comprises an ultra-fine mineral fraction having a size approximately 0.15 mm by 0.044 mm.

4. The system of claim 1, wherein the mineral comprises coal.

5. The system of claim 1, wherein the at least one spiral separates the third mineral fraction into clean mineral, middlings and refuse.

6. The system of claim 1, further comprising at least one third classifying cyclone receiving the clean mineral from the at least one spiral and removing any residual particles smaller than the predetermined second size from the clean mineral.

7. The system of claim 1, where a constant pressure is maintained at the at least one spiral inlet.

8. In a mineral preparation plant receiving a raw mineral feed and separating the raw mineral feed into coarse and finer sized mineral fractions, a method for separating a portion of the finer sized mineral fraction into clean mineral and refuse, said method comprising the steps of:
sizing the finer sized mineral fraction to develop a pre-sized mineral fraction within a first size range; and
receiving, at at least one spiral, the pre-sized mineral fraction, wherein the at least one spiral separates the pre-sized mineral fraction into clean mineral and refuse.

9. The method of claim 8, further comprising the step of adding water to the pre-sized mineral fraction at the at least one spiral inlet to maintain a constant flow through the at least one spiral.

10. The method of claim 8, wherein the mineral comprises coal.

11. The method of claim 8, wherein the at least one spiral separates the pre-sized mineral fraction into clean mineral, middlings and refuse.

12. The method of claim 8, further comprising the step of removing residual particles smaller than the first size range from the clean mineral output by the at least one spiral.

13. The method of claim 8, wherein the first size range comprises a range approximately 0.15 mm by 0.044 mm.

14. The method of claim 8, further comprising the step of maintaining a constant pressure at the at least one spiral inlet.

15. In a mineral preparation plant receiving a raw mineral feed and separating the raw mineral feed into coarse and finer sized mineral fractions, a method for separating a portion of the finer sized mineral fraction into clean mineral and refuse, said method comprising the steps of:
removing, from the finer sized mineral fraction, an ultra-fine mineral fraction having a size approximately 0.15 mm by 0.044 mm; and
feeding the ultra-fine mineral fraction to at least one spiral, wherein the at least one spiral separates the ultra-fine mineral fraction into clean mineral and refuse.

16. The method of claim 15, further comprising the step of removing residual minus 0.044 mm particles from the clean mineral output by the at least one spiral.

17. The method of claim 15, further comprising the step of maintaining a constant pressure at the at least one spiral inlet.

18. The method of claim 15, wherein the mineral comprises coal.

19. The method of claim 15, wherein the at least one spiral separates the ultra-fine mineral fraction into clean mineral, middlings and refuse.

20. The method of claim 15, further comprising the step of adding water to the ultra-fine mineral fraction at the at least one spiral inlet to maintain a constant flow through the at least one spiral.
